(19) United States
(12) Patent Application Publication
(10) Pub. No.: US 2006/0003828 A1
(43) Pub. Date: Jan. 5, 2006

(54) System for electronic gaming transactions

(75) Inventor: Michael Abecassis, Weston, FL (US)

Correspondence Address: VENABLE LLP, P.O. BOX 34385, WASHINGTON, DC, 20045-9998, US

(73) Assignee: Mike Abecassis, Weston, FL (US)

(21) Appl. No.: 11/171,507

(22) Filed: Jul. 1, 2005

Related U.S. Application Data
(60) Provisional application No. 60/584,171, filed on Jul. 1, 2004.

(51) Int. Cl. A63F 13/00

(52) U.S. Cl. 463/16; 463/42

(57) ABSTRACT

A device for electronically communicating information relating to wagering for table games includes a plurality of player consoles, a dealer console and a processor is disclosed. Each player console, that includes a graphic display, is configured to debit a player's account, receive input relating to the wager and transmit the information to a central processor. The dealer console also has a processor that receives the wagering information from the players, displays the information and is configured to receive input relating to the game outcome for each respective player. In response to a winning event, the dealer console can transmit the wager result to said players' console and credit the account.

### FIELD OF THE INVENTION

The present invention relates to improvements for casino games used in connection with gaming and includes an improved system for gaming from remote locations and systems and methods that may be used to implement these improvements.

### BACKGROUND OF THE INVENTION

Gambling or “gaming” is a popular recreation and amusement activity for adults. In order to enjoy gaming, most people had to travel to Las Vegas, Nevada, or Atlantic City, N.J. or offshore to enjoy many of the popular gaming attractions. While many states allow some forms of gaming such as lotteries and bingo, many people had to travel to enjoy casino gaming.

So called “off track betting” on horseracing has become popular in many states. In such facilities, patrons can place wagers on horse races being run at remote race tracks. The races can be viewed live on a television monitor and, if successful, the patron can collect their winning wager at the off track betting facility. It is believed that one of the reasons why off track betting of horseracing has also been commercially successful is that the betting event is taking place live. Because it is live, there is more excitement in the event, and the patron has confidence that the event is in no way manipulated by the entity that is showing the event.

Online gaming has also become popular. However, most online gaming is not as enjoyable to play as conventional casino games because the players do not understand how the outcome is being determined. For example, in a virtual card game, there is no way of determining how the cards are being provided to the player. In most online gaming applications, results are determined by a random number generator, which is not understood or appreciated by a player. In the alternative, many of the games purposefully use “seeded decks” in which the number of winning hands is artificially increased or decreased. While the increase in the number of winning hands adds further interest to the game, it results in the reinforcement of a sentiment that the games may be manipulated against a player's interests. Further, because many of the games are played over the internet from non-US providers, the player may not have a manner to redress to unfair or illegal games of chance.

### BRIEF SUMMARY OF THE INVENTION

While horseracing has used live events for betting, the only other real live action setting of this type is sports betting, for example, basketball and football games. The present invention uses this live action concept and applies it to conventional table games such as craps, roulette, blackjack, poker and slots. Rather than playing a virtual game, the instant invention allows the remote play of live games that are taking place. In a preferred embodiment the live game event is in a public forum, such as a casino. In alternative embodiments of the invention, the live event game that is played includes an electronic wagering system and an electronic display of the wagering process. In yet another alternative, a remote player may select a live player to act as a surrogate for live action. These surrogate players may be an amateur, professional or a celebrity, and may or may not be aware of the remote player's selection.

### BRIEF DESCRIPTION OF THE DRAWINGS

FIG. 1 shows an exemplary embodiment of the present invention.

FIG. 2 shows the embodiment of FIG. 1 used with blackjack.

FIG. 3 shows a player console used in the example of FIG. 2.

FIG. 4 shows the embodiment of FIG. 1 used with roulette.

FIG. 5 shows another exemplary embodiment of the present invention.

FIG. 6 shows a remote player console used in one embodiment of the present invention.

### DETAILED DESCRIPTION OF THE INVENTION

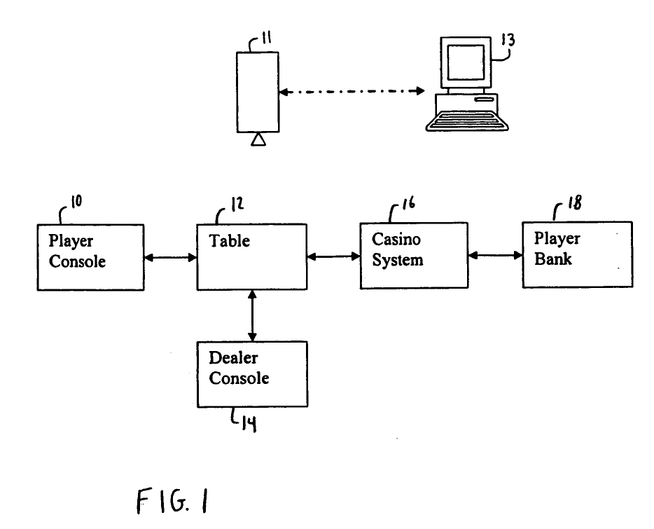

The system in accordance with the present invention can be used with a table game at a casino. Table games are typically games played at the casino at a “table” with live action with dice, cards and casino chips, as opposed to slot machines or video poker. Examples of table games include roulette, blackjack, craps, poker, baccarat, mini baccarat, paigow, Caribbean stud, Spanish 21 and let it ride. Such a system is schematically illustrated in FIG. 1. The system includes a player console 10 for a live player that comprises a monitor with a touch screen display, keyboard or pointing device provided at a player position at a playing table 12. The player console 10 communicates with the playing table 12, which is connected to a dealer console 14 and a larger, casino system 16, which can include a player's gaming account. The casino system 16 can access a player bank 18, which can be any financial account, for example a bank account, and/or credit card account. In alternate embodiments, the player console 10 can be connected directly to the casino system 16 and/or the player's bank 18. In an additional embodiment, the player console can be provided with a credit card/debit card reader or currency acceptor to create a player account. When the player has completed play, a receipt, token, or chips may be provided that can be redeemed at the casino window.

Generally, the player uses the player console 10 to place a wager. The player station can be used for both selecting the amount of the wager and implementing the particular gaming options for the playing table 12. Once the wager is placed, the game proceeds. When the game is over, the dealer inputs the game result at the dealer console 14. The dealer console 14 sends a signal to the player console 14 via the playing table 12, and the invention calculates a result based on the result of the game and the player's wager. The player's winning and losing wagers are credited or removed from the player 18 as appropriate. In the preferred embodiment, the player removes a set amount from the player bank 18 and maintains the set amount in the player console 10, e.g. a virtual chip stack. If necessary, the player at the player console 10 can remove additional money from the player bank 18 to replenish the amount shown in the player console 10 or deposit money into the player bank 18 from the player console 10. In an alternate embodiment, the player bank 18 is credited or debited based on each wager.

The player console 10 can include a display showing all of the players' wagers and the payout after the game is completed. The casino system 16 can be used to track the player's overall gaming, session gaming, and rewards programs. In the example, the embodiment of the invention does not generate a gaming result. It only manages the wagers and possibly the gaming options at a particular table.

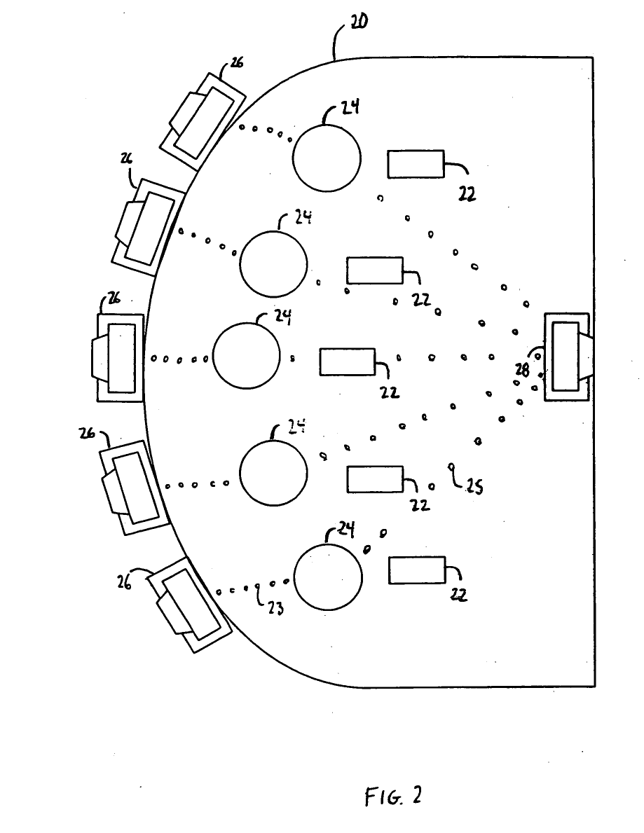

One example of the first embodiment is shown in FIG. 2, in which the game comprises blackjack. Reference number 20 depicts a blackjack layout similar to a conventional blackjack casino table. In the illustrated example, five player positions are provided, with five card boxes 22, five wagering circles 24 and five player consoles 26. A player makes a wager in the player console 26. The amount of the wager can appear in the wagering circle 24. A train of lights 23 can run from the player console to the wagering circle 24 to indicate the wager from the player console 26 “arriving” in the wagering circle 24. The value of the wager is then displayed so that all the players can see the amount. The display may include both a numerical representation and/or a graphic representation of the amount of the wager, for example, a 3D hologram of chips. Once the wagers from all the players are placed, play of the game proceeds. A player can use traditional hand signals to indicate game play options during playing the game, for example, a wave of the hand indicates “stay,” a vertical scratch on the table indicates “hit,” and horizontal scratch on the table indicates “surrender.” In an alternative embodiment, game play options can be inputted into the player console 26 and displayed to the dealer and/or table. If the player wins the game, the dealer will acknowledge the win, and control the payout via a dealer console 28. In this sequence, a signal can be generated that indicates a win, such as green light, and the amount of the total payout is displayed on the wagering circle 24. If the player loses the game, an electronic message can displayed and the wager in the wagering circle 24 is removed. A train of lead lights 25 extend from the wagering circles 24 to the dealer console 28 and can indicate money won or lost from the wagering circles 26.

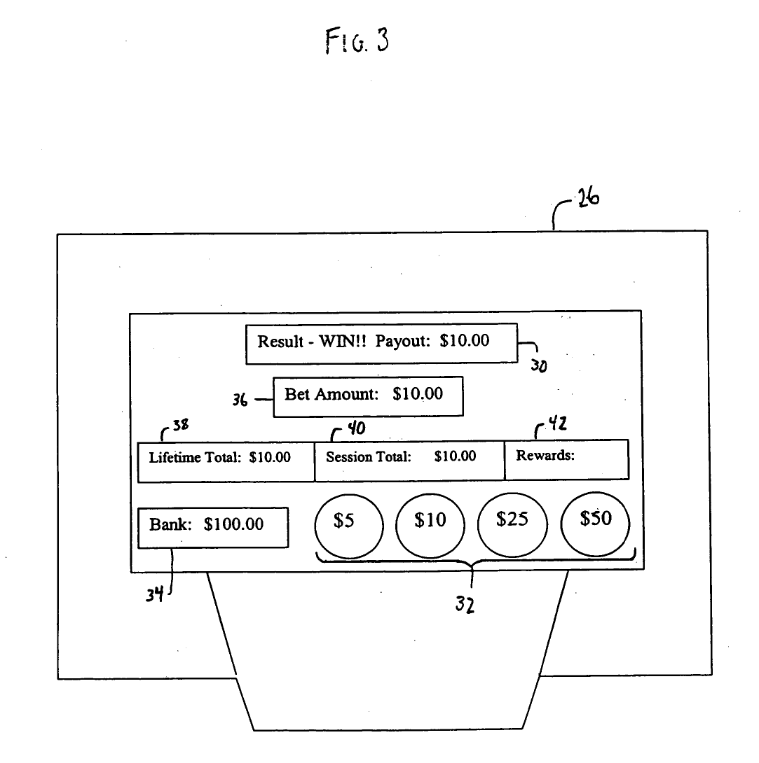

FIG. 3 shows an exemplary embodiment of a display on the players console 26. Box 30 shows a result of the immediately preceding game and the resulting payout. For example, in the illustrated display, the player bet $5 and won, resulting in a “WIN” display and a payout of $10.00. Area 32 displays the virtual chip stack that the player is playing with. The total of the chip stack 32 is shown in box 34. Box 36 displays the amount of the upcoming bet. To place the bet, a player can touch and drag a chip amount into the bet amount box, or the screen can be provided with arrows to raise and lower the bet when touched. The bet amount 36 can also be displayed as a virtual stack of chips. Box 38 displays the total amount won or lost by the player at the casino. Box 40 displays the amount won or lost by the player at the casino during the current playing session. The player console 26 can be programmed for minimum and maximum bets, depending on the table limits. The player console 26 can also be activated or deactivated to prevent wagers at an inappropriate times, such as when game play has begun.

Many casinos have rewards programs in which, typically, players are provided with cards having magnetic strips that identify the player and link the player to a rewards or gaming account. The player can use the players card to accumulate “points” in slot machines or at the tables based on average wager amount and playing duration. Players can usually check on the accumulation of points at kiosks or at a customer service station. The casinos use these programs to award “comps” in the form of room, food and beverages to loyal players. Box 42 displays the rewards accumulated by the player. The player console 26 can have a card reader (not shown) to read the player card of the player or the player can enter some other kind of identifier into the player console 26.

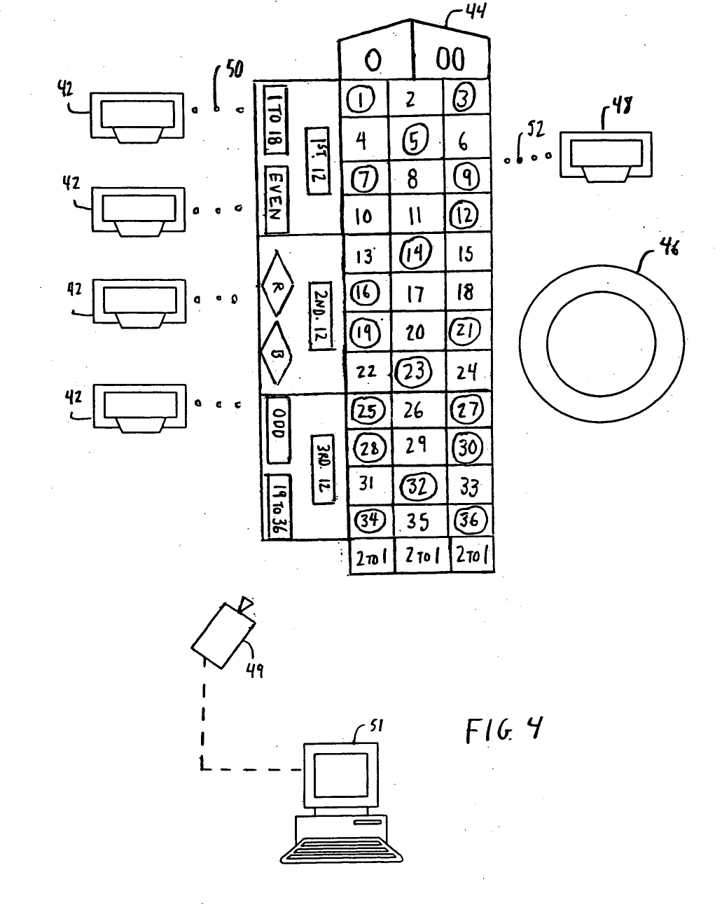

For example, as shown in FIG. 4, the game can be roulette. A number of player consoles 42 can be provided at a roulette table. Similar to the player console 26 of the blackjack embodiment, each player console 42 has a display for placing a wager. Player console 26 is configured for placing a roulette wager, for example, an electronic display showing all possible roulette bets and the player's bank of money. The player console 26 could show a virtual roulette table layout and a pile of virtual checks for placement on the virtual roulette table. The player can indicate where he wants to place his checks by touching the appropriate position on the table layout. In this case, the player touches a $1 check and touches 1, 2, 3, 4, and 5 to indicate placement of a check on each of those numbers. The dealer calls that bets are closed, and spins the roulette wheel 46. Once the ball comes to rest, for example, on 5, the dealer inputs the result at a dealer console 48. The system would then credit $35 worth of checks to the winning player for predicting the correct result. The system can also have a common electronic display for showing all of the players' bets on the roulette table 44 itself. The system can also be modified such that the result of the game is automatically detected by the system to eliminate the necessity of a dealer manually inputting the result. The system can also include lead lights 50 to indicate placement of the wager by the player, and lead lights 52 to indicate finalization of the result by the dealer.

As can be seen from the roulette example, the system of the present invention results in a number of advantages. Primarily, the system speeds up the game to allow more games per hour to result in higher profit for the casino. The system speeds up the betting process by allowing every player to place their bets at the same time without interference from other players and by allowing betting at a gaming station as opposed to manually placing checks on a relatively large roulette table. The game is also sped up because the dealer does not have to calculate and pay out winning bets and does not have to remove losing checks. The dealer also does not have to “color out” departing players. Furthermore, by placing wagers electronically at the player station, a dealer can “lock out” further bets once the betting period closes, thereby eliminating illegal “late betting.” Yet a further advantage is that the location of the bet is clear and situations where the bet is not clearly on the location desired is prevented. Confirmation of the bet may be provided on the player console 42 including the amount of the bet and the location of the bet as it would be represented on the convention felt betting surface of the roulette table 44.

Although roulette and blackjack are provided as examples, the present invention can also be used with other games, such as craps, poker, baccarat, mini baccarat, paigow, Caribbean stud, Spanish 21 and let it ride.

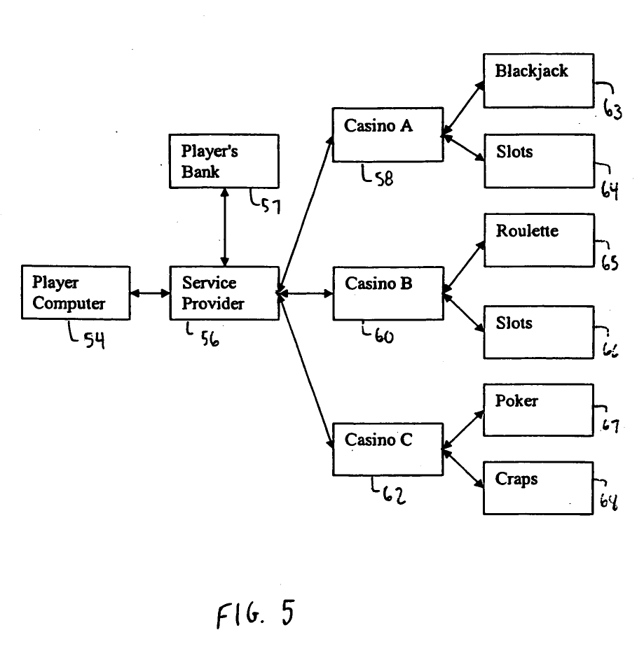

A second embodiment of the present invention is shown by FIG. 5. This embodiment improves on online gambling by incorporating live action in a remote setting. This live action may be transmitted to a player at a computer 54 via a service provider 56 that provides an internet connection or a direct feed over a conventional cable, phone or satellite network. Moreover, in a preferred embodiment the live action game is located at a public location, for example, a casino that may or may not offer the game itself or an offsite betting establishment.

Thus in this alternate embodiment, the service provider 56 connects a player to one or more casinos 58, 60, 62 that provides a continuous feed of a selection of games 63-68. Thus a player may have the choice of playing a game in Las Vegas at, for example, the MGM Grand or the Bellagio or in Monaco at the Monte Carlo.

A schematic example is also shown in FIGS. 1 and 4. As shown in FIG. 1, the camera 11 views table 12 and is connected to a remote player console 13. As shown in FIG. 4, a camera 49 can provide a continuous feed of the games to be played. The table game can be a conventional casino table game with the exception that each game is provide with a unique serial number or other identifier that identifies the particular game and/or includes the start time and finish of the particular game as well as an input that tracks the timing of certain game play actions so that the gaming action and/or wagering is completed before the results are depicted or determined. In this regard, the action executed may be controlled by the house dealer or automated.

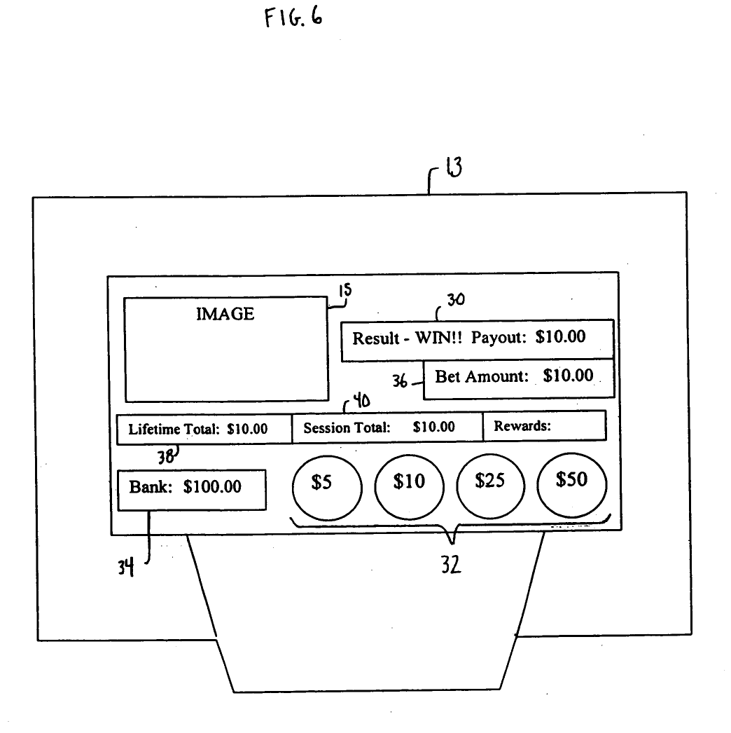

A second embodiment is similar to the first embodiment, except that the system is used over the internet or other network at a remote venue or location. The player console can be the personal computer 54 with a display showing a live, visual image of the table game. An example of such a player console is shown in FIG. 6, which shows a player console that is similar to the player console shown in FIG. 3 except that an image of the live game is shown in box 15. The wager is placed in accordance with the first embodiment, and game play proceeds as in the first embodiment, except that the player is viewing the game at a remote location instead of at the casino. The dealer inputs a result at a dealer station. The system calculates a result based on the game result and the player's wager, and the player's winning and losing wagers are credited or removed from the player bank 57 as appropriate.

This embodiment can also be used by players at home over the internet or in larger venues, for example, a group of people watching the games on a large screen with individual playing consoles. Player consoles can be set up at bar and restaurants.

This embodiment is superior to conventional internet gambling in that the results of the game and the game itself are not virtual, i.e., merely a result of a random number generator. The game is being played live by real players and real dealers and is being broadcast to the remote player. Viewing a live game at a casino gives the player the sense that the game is more “fair” than conventional online gaming.

For example, the gaming event in this embodiment could be a slot machine. A live image of a slot machine is broadcast to remote locations either via a cable modem or closed circuit television. The machine may be programmed to automatically spin the wheels at a predetermined time, or the play may be implemented by an actual player. The play on the machine would be modulated to allow adequate time window that could bet on the outcome of the event. For example, a player could place their bet on a spin that occurred every 30 seconds. According to the present invention, a player could then play an actual slot machine, albeit from a remote location. In an alternative embodiment, the could actually control the operation of the slot using a command over the internet that causes the reels on the slot to begin to spin and to stop the reels at designated time. The slots would be a public forum and could be observed and include a display of the name of the individual that was actually the slot from remote locations.

In addition to the playing of the games themselves, the televising of actual gaming has entertainment values. In addition to joining a game, the prospective player may view the game to learn how the game is played and enjoy seeing other players win or lose at the game.

In yet another aspect of this embodiment, the camera may be positioned to show the live players. In this embodiment, the remote player may select a player at the table and bet for or against a particular player.

In this embodiment, the casino may have a number of “designated players” who would stand in the place of the actual player or players. These players would implement the live action for the remote players, be it rolling dice, pulling a slot handle, or accepting dealt cards. These individuals may be volunteers or employees of the casino. Popular designated players may increase the amount of play because the remote players would build an affinity for the players. For example, a designated player may be a celebrity that would play for the remote player.

It will be apparent to those skilled in the art and it is contemplated that variations and/or changes in the embodiments illustrated and described herein may be made without departure from the present invention. Accordingly, it is intended that the foregoing description is illustrative only, not limiting, and that the true spirit and scope of the present invention will be determined by the appended claims.

What is claimed is:

1. A device for electronically communicating information relating to wagering at a table game comprising a plurality of player consoles, a dealer console and a processor, said a player console further comprising means to debit a player account, means to display said account information, means to input data relating to a game wager, and means to transmit said data to a central processor, and said dealer console comprising display means for displaying said player input data and/or data and means for data input for receiving input relating to a game outcome for each respective player, and processor means for determining a wager result with respect to each wager, and transmission means to transfer the wager result to said players' console, wherein the table game is played in a conventional manner and information relating to wagering is therefore electronically transmitted between said dealer console and said player console.
